(19) United States
(12) Patent Application Publication
(10) Pub. No.: US 2024/0359323 A1
(43) Pub. Date: Oct. 31, 2024

(54) DATA FLOW SERVICE FOR ROBOTIC BEHAVIOR TREES

(71) Applicant: Intrinsic Innovation LLC, Mountain View, CA (US)

(72) Inventors: Michael Beardsworth, San Francisco, CA (US); Andreas Heiner Bihlmaier, Puchheim (DE); Bala Venkata Sai Ravi Krishna Kolluri, Fremont, CA (US)

(21) Appl. No.: 18/530,029

(22) Filed: Dec. 5, 2023

Related U.S. Application Data
(60) Provisional application No. 63/498,488, filed on Apr. 26, 2023.

(51) Int. Cl. B25J 9/16

(52) U.S. Cl. CPC B25J 9/1661; B25J 9/161; B25J 9/163

(57) ABSTRACT

Methods, systems, and apparatus, including computer programs encoded on computer storage media, for planning and executing robotic processes. One of the methods includes receiving a definition of a robotic behavior tree, receiving a definition of a data flow graph, and executing a robotic process using the definition of the robotic behavior tree and the data flow graph.

### CROSS-REFERENCE TO RELATED APPLICATION

This application claims priority to U.S. Provisional Application No. 63/498,488, filed on Apr. 26, 2023. The disclosure of the prior application is considered part of and is incorporated by reference in the disclosure of this application.

### BACKGROUND

This specification relates to robotics, and more particularly to planning and executing robotic processes.

Robotics planning refers to scheduling the physical movements of robots in order to perform tasks. Robotics planning has traditionally required immense amounts of manual programming in order to meticulously dictate how the robotic components should move in order to accomplish a particular task. Manual programming is tedious, time-consuming, and error prone.

Robotic behavior trees with nodes and links can be used to represent desired robot behavior that can be executed. Although robotic behavior trees typically can control the flow of operations at nodes, robotic behavior trees typically cannot control the flow of data between nodes. For example, a conventional robotic behavior tree may use a shared data space that nodes can read and write to, which may lead to errors when reading or writing high frequency or high bandwidth data.

### SUMMARY

This specification describes how a robotic system can use data flow graphs to control the flow of data in a process defined by a robotic behavior tree. The data flow graph includes data connections between nodes in the robotic behavior tree. Given a definition of a robotic behavior tree and a data flow graph, the robotic system can execute a robotic process according to the definition of the robotic behavior tree and the data flow graph.

In this specification, a behavior tree is a graph-based data structure representing a robotic process. A behavior tree has nodes and links, with the links establishing parent-child relationships between nodes. A robotic execution system can use an event-driven behavior tree to execute a robotic process by stepping through the nodes according to the node semantics of different types of nodes. As one example, a sequence node having four leaf nodes as children can represent that the robot should execute the four leaf nodes in the specified sequence. A behavior tree being event-driven means that evaluation of the behavior tree will remain at some nodes until an associated task or an action, typically performed by a robot or another hardware component in a robotic operating environment, has completed. Event-driven behavior trees are thus distinct from time-based behavior trees that are reevaluated at each tick of an evaluation cycle, which are typically on the order of 1 to 100 Hz or more. Thus, the process represented by the behavior tree is performed once per tree traversal. Additional node semantics of behavior trees will be described in more detail below.

In this specification, a data flow graph is a graph-based data structure representing a flow of data between leaf nodes in a behavior tree. A robotic execution system can use a data process to execute a data flow graph by sending and receiving data to and from leaf nodes in the behavior tree according to the definition of the data flow graph.

Particular embodiments of the subject matter described in this specification can be implemented so as to realize one or more of the following advantages.

A system executing a robotic process using a definition of a robotic behavior tree and a definition of a data flow graph can control the flow of actions and the flow of data with separate but collaborating data structures. The data flow graph describes data connections between nodes of the robotic behavior tree, and the flow of data over the data connections can be executed asynchronously from the robotic behavior tree. The system can coordinate the execution of the robotic behavior tree and the data flow graph, for example, by sharing progress signals between the processes that execute the robotic behavior tree and the data flow graph.

The system can allow for increased user friendliness in robotics planning and programming. For example, the system receives and executes a definition of a robotic behavior tree and a data flow graph, but there is no functional difference to a user. In addition, the system can include type-checking for checking the datatypes of values in data that flows over data connections of the data flow graph. Type-checking can lead to reductions in compile-time and runtime errors, increasing the ease of use for a user.

Increased user friendliness in robotics planning and programming can also reduce runtime errors. Reductions in runtime errors, for example, due to type-checking, can decrease the computing resources, time, and power resources used for executing robotic processes that otherwise would have run but would not have been completed due to the errors.

The system can allow for flexibility in the execution of the robotic process. For example, the definition of a data flow graph can include what skills should do if data received over a data connection is undefined. The definition of the data flow graph can also include a priority, permission, and/or frequency for data connections. The system also allows for storage of received data if there are no recipients for the data so that the data is not lost.

The control flow, as defined through the behavior tree, and its visualization during execution, can aid the user in reasoning about what happens in the application process and when it happens. The data flow, as defined in the data flow graph, together with a visualization of the data flow graph, can aid the user in understanding how information passes through the system. Taken together, the control flow and the data flow, serve as entry points to introspection and debugging facilities. For example, the user could specify to record a specific portion of the data flowing through the system while the system is in a particular state by connecting probe points to the data flow graph and using the behavior tree's nodes as a trigger.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram that illustrates an example system.

FIG. 2 is a diagram of an example data flow graph.

FIG. 3 is a diagram of an example behavior tree with an example data flow graph.

FIG. 4 is a flowchart of an example process for executing a robotic process using a definition of a robotic behavior tree and a data flow graph.

Like reference numbers and designations in the various drawings indicate like elements.

### DETAILED DESCRIPTION

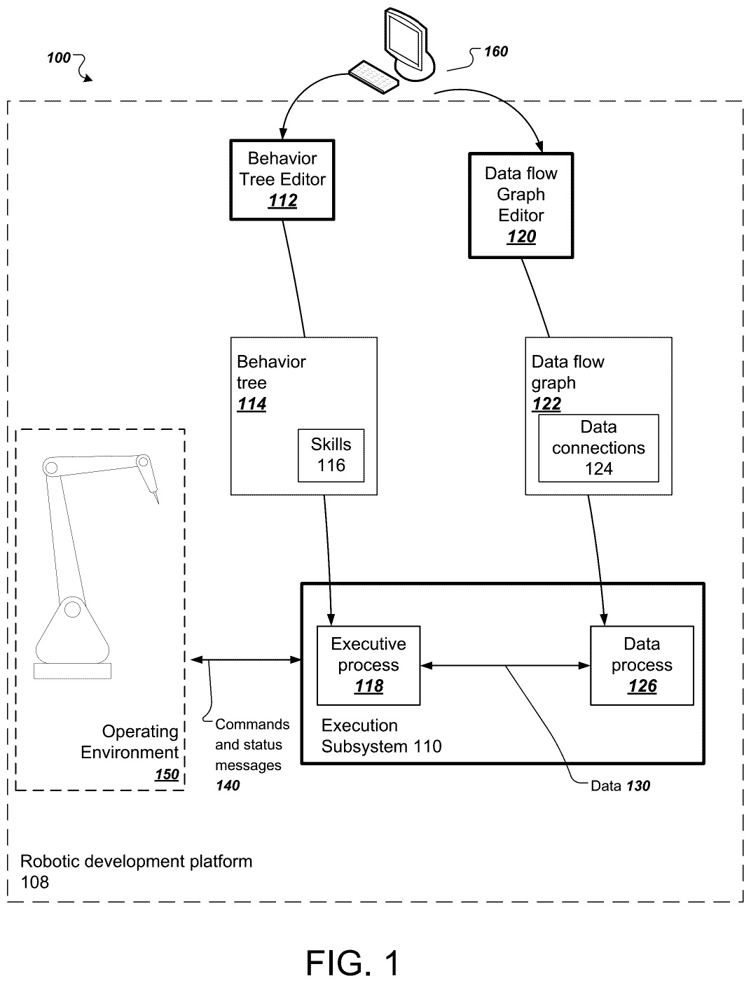

FIG. 1 is a diagram that illustrates an example system 100. The system 100 is an example of a system that can implement the behavior tree and data flow graph execution techniques described in this specification.

The system 100 includes a user device 160 and a robotic development platform 108, which is operable to drive a robot in an operating environment 150 using a behavior-tree representation of a robotics process. The robotic development platform 108 can then generate output code that is specific to any number of execution systems, which do or cannot operate on behavior-tree representations.

The robotic development platform 108 includes a number of functional subsystems, including a behavior tree editor 112, a data flow graph editor 120, and an execution subsystem 110. Each of these components can be implemented as computer programs installed on one or more computers in one or more locations that are coupled to each other through any appropriate communications network, e.g., an intranet or the Internet, or combination of networks.

The behavior tree editor 112 is a user input system that allows a user to create, design, or modify an event-driven behavior tree. For example, the behavior tree editor 112 can provide a user interface to the user device 160 that allows the addition, deletion, or modification of nodes and links in the tree. The user interface can be a graphical user interface, e.g., as part of an integrated development environment, or the user interface can be command-line based. Alternatively or in addition, a user can upload a textual representation of a behavior tree, e.g., as written in a particular behavior tree language. The user device 160 can be any appropriate computing device for providing commands to the robotic development platform 108, e.g., a smart phone, a tablet computer, a laptop computer, or a desktop computer, to name just a few examples.

The data flow graph editor 120 is a user input system that allows a user to create, design, or modify a data flow graph. For example, the data flow graph editor 120 can provide a user interface to the user device 160 that allows the addition, deletion, or modification of nodes and data connections in the data flow graph. The user interface can be a graphical user interface, e.g., as part of an integrated development environment, or the user interface can be command-line based. Alternatively or in addition, a user can upload a textual representation of a data flow graph. In some implementations, the data flow graph editor 120 and the behavior tree editor 112 can be integrated into the same user interface, e.g., an integrated development environment.

The execution subsystem 110 can be any appropriate type of computing device, computing system, cloud-based system, software, and/or network of computing devices/systems that executes the behavior tree and the data flow graph. The execution subsystem 110 can drive the actions of the robot in the operating environment 150, which can be, for example, a workcell. The execution subsystem 110 provides commands to and receives status messages 140 from the operating environment. In doing so, the execution subsystem 110 can control a real-time robotics control system with hard real-time requirements. Real-time software control systems are software systems that are required to execute within strict timing requirements to achieve normal operation. The timing requirements often specify that certain actions must be executed or outputs must be generated within a particular time window in order for the system to avoid entering a fault state. In the fault state, the system can halt execution or take some other action that interrupts normal operation.

The execution subsystem 110 includes an executive process 118 and a data process 126. The executive process 118 is configured to execute a behavior tree and the data process 126 is configured to execute a data flow graph.

In a typical scenario, the execution subsystem 110 receives a behavior tree 114 and executes the robotic process represented by the behavior tree 114 using the executive process 118. The executive process 118 steps through the nodes, and, at each node, performs an operation represented by node semantics of the node. Leaf nodes in the behavior tree 114 are skills 116 that represent one or more actions for the robot to perform.

The execution subsystem 110 also receives a data flow graph 122 and executes the data flow graph 122 using the data process 126. The data flow graph 122 describes data connections 124 between skills 116 in the behavior tree 114. In some implementations, the data process 126 can execute multiple data flow graphs.

Thus, when the executive process 118 encounters a skill, the executive process 118 kicks off the appropriate skill on the robot in the operating environment 150. The data process 126 also causes the skill to communicate according to the definition of the data flow graph 122.

The executive process 118 and data process 126 can communicate data 130. For example, data 130 can include data that should flow between skills 116 over data connections 124. In some implementations, the executive process 118 and data process 126 can communicate progress signals. Progress signals from the executive process 118 to the data process 126 can reset or modify certain data connections 124. For example, in response to receiving a progress signal, the data process 126 can remove certain data from data connections 124, or replace the data in data connections 124 with defined default values.

As mentioned above, the behavior tree 114 can be an event-driven behavior tree whose semantics dictate that evaluation or execution of the behavior tree remains with particular leaf nodes until the task associated with the leaf node completes, either successfully or unsuccessfully. Thus, a complete traversal, which need not visit all nodes, is performed once for each iteration of the process the behavior tree represents.

The evaluation of each node of the behavior tree can have an associated node outcome, which can be any appropriate status indicator or return value. For example, the evaluation of each node can be associated with a value indicating whether the node outcome was success or failure. The node outcomes can then be used by parent nodes to control evaluation of the behavior tree according to the node semantics of the parent nodes.

A skill can be of arbitrarily complex functionality, e.g., can include multiple actions. In some implementations, a skill is a collection of preconfigured data and software, e.g., a machine learning control model, that provides a robot a capability to perform a task or a portion of a task represented by a leaf node. Each skill may itself encapsulate a state machine that guides the robot through one or more subtasks in order to effectuate the full task. For example, a skill can represent robot capabilities such as perception, motion, manipulation, communication, input/output control, etc. Suitable techniques for configuring robots to execute tasks using skills are described in commonly owned U.S. patent application Ser. No. 16/880,869, filed on May 21, 2020, which is herein incorporated by reference.

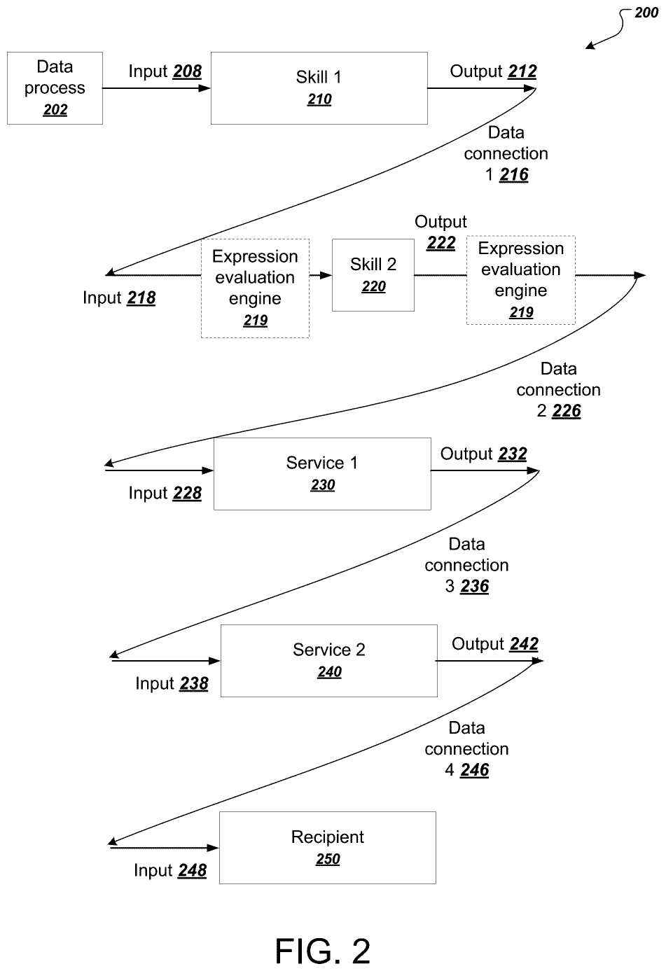

FIG. 2 is a diagram of an example data flow graph 200. The data flow graph 200 can include skills such as skill 1 210 and skill 2 220, services such as service 1 230 and service 2 240, and subscribers or recipients such as recipient 250. The data flow graph 200 can be executed by data process 202. Data process 202 can provide data between skills, services, and recipients through data connections 216, 226, 236, and 246. The data that flows through data connections can include multiple values, and each value can have a different datatype. For example, datatypes can include integers, decimals, floats, text, commands, image data, sensor data, etc.

In some implementations, data processes such as data process 202 can perform type-checking on the values in the data, for example, before data flows through a data connection. Type-checking ensures values are in the correct format for use by recipients, and can lead to reductions in compile-time and runtime errors.

Data process 202 can provide data as input 208 to skill 1 210. After an executive process executes skill 1 210, the values of the data in input 208 may be updated. Output 212 can reflect the updated values. Output 212 can also include new or different data. The data process 202 can provide the output 212 to skill 2 220 as input 218 over data connection 1 216.

In some implementations, the system can include an expression evaluation engine 219. The expression evaluation engine can unpack the input 218 before providing the input 218 to skill 2 220, for example. For example, the expression evaluation engine 219 can transform or convert the values in input 218 from one datatype to another datatype. The expression evaluation engine 219 can also extract a subset of the values in input 218. The expression evaluation engine 219 can also evaluate the values in input 218, for example, by comparing the values to threshold values and outputting the results of the evaluation.

When passing data between skills over data connections, such as over data connection 2 226, the execution of skills is not affected. For example, although skill 2 220 receives input 218, skill 2 220 will not be executed until executed by the executive process.

After the executive process executes skill 2 220 given the input 218, the values of the data in input 218 may be updated. Output 222 can reflect the updated values. In some implementations, the expression evaluation engine 219 can pack the output 222, for example, by performing reverse operations, or similar types of operations, as were performed for unpacking the input 218.

The data process 202 can provide the output 222 as input 228 over data connection 2 226. When a skill sends data to a service, such as skill 2 220 sending data to service 1 230, the service forwards the data to one or more recipients. In the example data flow graph 200, service 1 230 forwards the data to service 2 240. That is, after the service 1 230 receives input 228, it does not need the executive process to execute.

After service 1 230 executes given input 228, the values of the data in input 228 may be updated. Output 232 can reflect the updated values.

In some implementations, an expression evaluation engine such as expression evaluation engine 219 can pack the input 228 or unpack the output 232 as described above.

The data process 202 can provide the output 232 as input 238 over data connection 3 236. When a service sends data to another service, such as service 1 230 sending data to service 2 240, the service forwards the data to one or more recipients. In the example data flow graph 200, service 2 240 forwards the data to recipient 250. Recipient 250 may be a skill or a service, for example.

After service 2 240 executes given input 238, the values of the data in input 238 may be updated. Output 242 can reflect the updated values.

In some implementations, an expression evaluation engine such as expression evaluation engine 219 can pack the input 238 or unpack the output 242 as described above.

The data process 202 can provide the output 242 as input 248 over data connection 4 246. For example, if recipient 250 is a skill, a service sending data to a skill does not affect the execution of the skill. That is, if recipient 250 is a skill, recipient 250 will not be executed until the executive process executes recipient 250.

In some implementations, a recipient 250 such as a service or a skill can have no inputs or no outputs. For example, recipient 250 has zero outputs.

In some implementations, an expression evaluation engine such as expression evaluation engine 219 can pack the input 248 as described above.

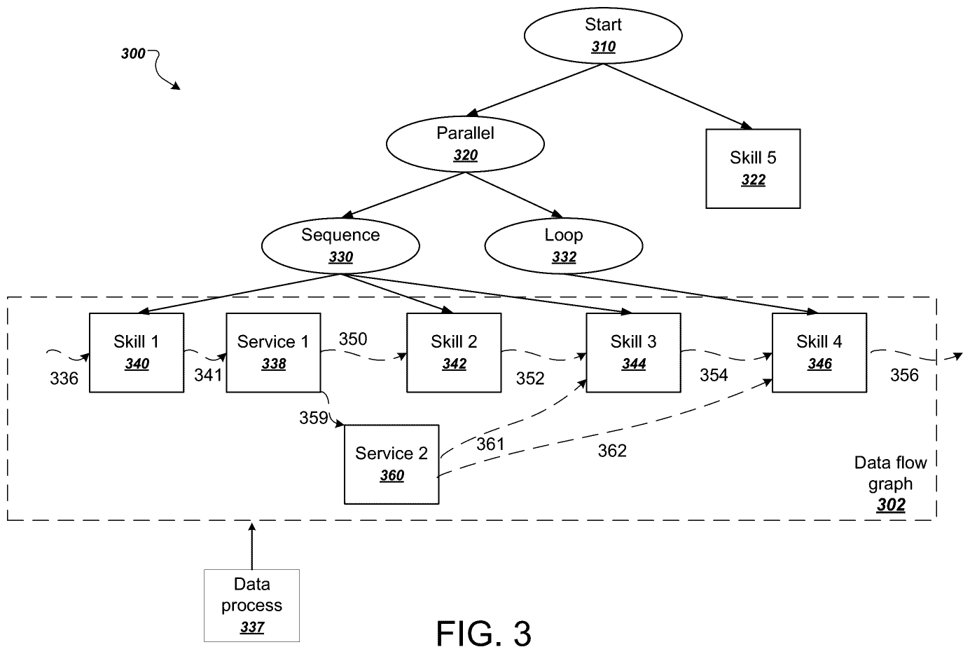

FIG. 3 is a diagram of an example behavior tree 300 with an example data flow graph 302. The oval-shaped nodes 310, 320, 330, and 332 are control nodes, and the square-shaped nodes 340, 342, 344, 346, and 322 are leaf nodes. A system can represent a robotic process with a behavior tree as shown.

Node semantics of the control nodes dictates how an executive process will walk through nodes of the behavior tree to direct the robotic process. As one example, a sequence node, e.g., the start node 310 or sequence node 330, dictates that the executive process should process all of its child nodes in a particular order specified by the behavior tree. Thus, the executive process would process the parallel node 320 before processing the leaf node 322.

As another example, a parallel node 320 specifies that the executive process should process all of its child nodes at least partially in parallel. The mechanism for implementing parallel execution in practice depends on the configuration of the operating environment. For example, the executive process can command multiple components in the workcell, e.g., a joint move and a gripper close, by providing commands sequentially but which are executed by their respective components at least partially in parallel. Alternatively or in addition, the executive process can launch multiple threads that execute in parallel to effectuate the specified actions.

Skills, e.g., the leaf nodes 340, 342, 344, 346, and 322, represent actions to be performed by a robot. For example, a leaf node can represent moving an end effector of a robot to a particular location in a workcell. Leaf nodes can also represent more sophisticated tasks, such as making a weld or inserting a connector into a socket.

The example behavior tree also includes a loop node 332. The loop node can re-execute its subtree until a particular condition is satisfied, which can include a counter reaching a particular number of iterations. Thus, the loop node 332 can cause the executive process to re-execute the leaf node 344 for a particular number of iterations.

The example behavior tree can also include a branch node. The semantics of the branch node represent an if-else control structure with an associated condition. For example, if node 330 were a branch node, if the condition holds, the system can evaluate the first leaf node 340. Otherwise, the system can evaluate the second leaf node 342.

The data flow graph 302 describes data 341, 350, 352, 354, 359, 361, and 362 that flows over data connections between skills 340, 342, 344, 346 and services 338 and 360. The data flow graph 302 can be executed by data process 337. Data process 337 may run regardless of the execution of the behavior tree 300. The behavior tree 300 and data flow graph 302 may be executed asynchronously. For example, data process 337 may run continuously.

The data flow graph can include services such as service 1 338 and service 2 360. For example, service 1 338 may be an object detection service that obtains visual data of a scene, such as image or video data, as input, and outputs data that represents locations of objects. Service 2 360 may be an obstacle detection service that obtains visual data of a scene, such as image or video data, as input, and outputs data that represents locations of obstacles in the vicinity that may prevent the robot from moving.

In this example, skill 1 340 may be a skill that moves the robot. Skill 2 342 may be a skill that waits for a specific type of block to be present in the scene. Skill 3 344 may be a skill that retrieves the specific type of block using a gripper. Skill 4 346 may be a skill that moves the gripper.

For example, skill 1 340 may receive an input 336 defining a movement for the robot, such as a location or orientation. When skill 1 340 is executed by the executive process, skill 1 340 can output data 341 that represents whether the move was successful.

The service 1 338 can already be running. The service 1 338 can receive data 341 and obtain visual data of the scene at the robot's new location. The service 1 338 can output visual data and/or data that represents locations of objects, for example, as data 350 and data 359.

The service 2 360 can already be running. The service 2 360 can receive data 359 that represents visual data and/or data that represents locations of objects. The service 2 360 can run and output data 361 and 362 that represents locations of obstacles that may prevent the robot from moving, without needing to be executed by the executive process.

Skill 2 342 can receive data 350, which can include visual data or data that represents locations of objects. Skill 2 324 can receive visual data and/or location data. When skill 2 324 is executed by the executive process, skill 2 342 can use data 350 to determine if the specific type of block is present. Skill 2 324 can output data 352 that represents the location of a specific type of block in the scene.

Skill 3 344 can receive data 352, which can include a location of a specific type of block in the scene. Skill 3 344 can also receive data 361 which represents the location of any obstacles in the vicinity of the robot. When skill 3 344 is executed by the executive process, skill 3 344 can perform the operation of retrieving the block at the location in data 352. Skill 3 344 can output data 354 that represents whether the retrieval was successful, for example, or physical characteristics of the block that can be measured by the gripper such as a weight of the block.

Skill 4 346 can receive data 354. Skill 4 346 can also receive data 362 which represents the location of any obstacles in the vicinity of the robot. When skill 4 346 is executed by the executive process, skill 4 346 can perform the operation of moving the gripper that is holding the retrieved block to a different location. Skill 4 346 can output data 356 that represents whether the move was successful, or a location of the gripper.

The data 356 can be input to a recipient such as another skill, e.g., skill 5 322, or service. In some implementations, data process 337 can reset or modify data connections in response to receiving a progress signal from the executive process. For example, the progress signal may indicate that data in data connection 216 is old or outdated. The data process 337 can delete the data in data connection 216. The data process 337 can also replace the data in data connection 216 with a default value.

In some implementations, the data process 337 can execute the data flow graph 302 according to a priority for the data 341, 350, 352, 354, 359, 361, and 362 flowing over the connections. For example, the definition of data flow graph 302 can include quality of service information for data connections that defines how important a data connection is. For example, the data 350 can be defined as high priority, so the data process 337 may want to ensure the data 350 flows over the connection before continuing execution of the data flow graph. The data 352 may have a lower priority, and the data process 337 may give a best effort to complete the data connection.

In some implementations, the data process 337 can execute the data flow graph 302 according to permissions for the data 341, 350, 352, 354, 359, 361, and 362. For example, the definition of the data flow graph 302 can include a permission for a data connection that defines which skills or services can receive the data in the data connection. For example, the permissions for the data 354 may state that skill 4 346 can receive information about physical characteristics of the retrieved block, but another recipient (not shown) of data 354 may not receive this information. The definition of the data flow graph 302 can also include a frequency that defines how often a data connection should be run, for example, once every 5 seconds. For example, as skill 4 346 runs in a loop, skill 4 346 may want to receive updated locations for obstacles in the scene from service 2 360 at a certain frequency before moving the retrieved block.

In some examples, the data process 337 can coordinate with the executive process. For example, a skill in a parallel branch of the behavior tree 300 can emulate an interaction between the executive process and the data process 337.

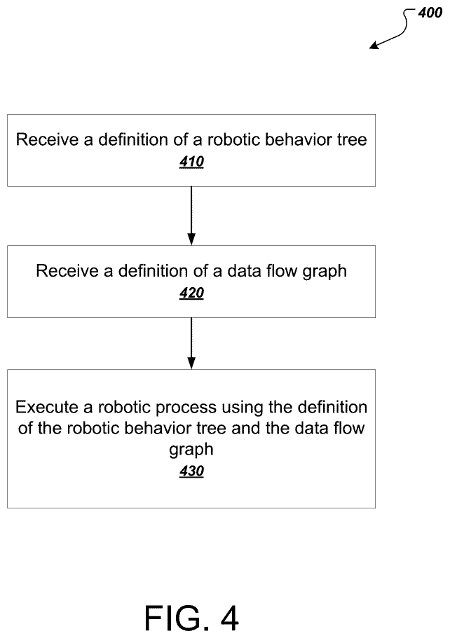

FIG. 4 is a flowchart of an example process for executing a robotic process using a definition of a robotic behavior tree and a data flow graph. The process 400 can be performed by any appropriate system, e.g., the execution subsystem 110 of FIG. 1.

The system receives a definition of a robotic behavior tree (410). The robotic behavior tree can include nodes, and leaf nodes of the robotic behavior tree can be skills.

The system receives a definition of a data flow graph (420). A data flow graph describes data connections between skills in the robotic behavior tree. The data connections can include data that has one or more values. In some implementations, the definition of the data flow graph can describe data connections between skills and services. In some implementations, the definition of the data flow graph can describe data connections between services.

In some implementations, the definition of the data flow graph can include how skills in the behavior tree operate if one or more values are undefined. For example, the system can specify that execution of the skill should be stopped until a value is received that is not undefined. As another example, the system can set the undefined value to a default value. As another example, the system can set the node outcome for the skill to a failure.

In some implementations, the values can have one or more datatypes. For example, the values can be numeric values such as integers or decimals, or text, etc.

In some implementations, the definition of the data flow graph can include a priority for one or more of the data connections. For example, the definition of the data flow graph can include quality of service information for data connections that defines how important a data connection is and/or whether the data process executing the data flow graph should ensure the data connection has been completed before executing the rest of the data flow graph.

In some implementations, the definition of the data flow graph can include a permission or a frequency for one or more of the data connections. For example, the definition of the data flow graph can include a permission for a data connection that defines which skills or services can receive the data in the data connection. The definition of the data flow graph can also include a frequency that defines how often a data connection should be run, for example, once every 5 seconds.

The system executes a robotic process using the definition of the robotic behavior tree and the data flow graph (430). For example, the system can cause the skills running due to execution of the behavior tree to communicate through the data process according to the definition of the data flow graph. In some implementations, an executive process can execute the behavior tree, and a data process can execute the data flow graph.

The system can execute the robotic process by executing the behavior tree and data flow graph asynchronously. While doing so, execution of the skills drives execution of the behavior tree, while the sending and receiving of data drives operation of the data flow graph. In other words, causing the skills to communicate can include passing data between skills on data connections that does not affect the execution of the skills in the behavior tree. For example, the skills may send and receive data to each other, but doing so will not invoke a recipient skill unless and until the executive process encounters the recipient skill during execution of the behavior tree.

In some implementations where the definition of the data flow graph describes data connections between skills and services, a skill sending data to a service causes the service to forward the data to one or more recipients. For example, recipients can include other skills or other services. In some implementations, if a service receives data without a corresponding recipient, the service can store the received data until receiving a subscription request for the data.

In some implementations, a service sending data to a skill does not affect the execution of the skill. For example, the skill will not be executed unless and until the executive process encounters the skill during execution of the behavior tree.

A data flow graph can also include nodes representing multiple services themselves. For example, the definition of a data flow graph can describe data connections between different services. In some implementations, a service sending data to a second service causes the second service to forward the data to one or more recipients. For example, other recipients can include skills or other services.

In some implementations, when a skill or service receives data on a data connection, an expression evaluation engine is configured to unpack the data. In some implementations, before the data is sent on a data connection, an expression evaluation engine is configured to pack the data.

For example, packing or unpacking the data can include transforming one or more of the values in the data from one datatype to another datatype, extracting a subset of the one or more values in the data, or evaluating one or more values in the data. For example, the expression evaluation engine can compare values in the data with threshold values.

In this specification, a robot is a machine having a base position, one or more movable components, and a kinematic model that can be used to map desired positions, poses, or both in one coordinate system, e.g., Cartesian coordinates, into commands for physically moving the one or more movable components to the desired positions or poses. In this specification, a tool is a device that is part of and is attached at the end of the kinematic chain of the one or more moveable components of the robot. Example tools include grippers, welding devices, and sanding devices.

In this specification, a task is an operation to be performed by a tool. For brevity, when a robot has only one tool, a task can be described as an operation to be performed by the robot as a whole. Example tasks include welding, glue dispensing, part positioning, and surfacing sanding, to name just a few examples. Tasks are generally associated with a type that indicates the tool required to perform the task, as well as a position within a workcell at which the task will be performed.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers.

The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:
Embodiment 1 is a method comprising:
receiving a definition of a robotic behavior tree, wherein the robotic behavior tree comprises nodes, wherein leaf nodes of the robotic behavior tree are skills;
receiving a definition of a data flow graph that describes data connections between skills in the robotic behavior tree, wherein the data connections comprise data with one or more values; and
executing a robotic process using the definition of the robotic behavior tree and the data flow graph, thereby causing the skills to communicate according to the definition of the data flow graph.
Embodiment 2 is the method of embodiment 1, wherein the definition of the data flow graph describes data connections between skills and services.
Embodiment 3 is the method of any one of embodiments 1-2, wherein the definition of the data flow graph describes data connections between services.
Embodiment 4 is the method of any one of embodiments 1-3, wherein executing the robotic process comprises executing the behavior tree and data flow graph asynchronously.
Embodiment 5 is the method of embodiment 4, wherein an executive process executes the behavior tree, and a data process executes the data flow graph.
Embodiment 6 is the method of any one of embodiments 1-5, wherein causing the skills to communicate comprises passing data between skills on data connections that does not affect the execution of the skills in the behavior tree.
Embodiment 7 is the method of embodiment 2, wherein a skill sending data to the service causes the service to forward the data to one or more recipients.
Embodiment 8 is the method of embodiment 2, wherein the service sending data to a skill does not affect the execution of the skill.
Embodiment 9 is the method of embodiment 3, wherein the service sending data to a second service causes the second service to forward the data to one or more recipients.
Embodiment 10 is the method of any one of embodiments 1-9, wherein the data connections comprise data with one or more values of one or more datatypes.
Embodiment 11 is the method of embodiment 7, wherein upon the service receiving data without a corresponding recipient, the service stores the received data until receiving a subscription request for the data.
Embodiment 12 is the method of any one of embodiments 1-11, wherein the definition of the data flow graph comprises how skills in the behavior tree operate if one or more of the values in the data are undefined.
Embodiment 13 is the method of any one of embodiments 1-12, wherein upon receiving data on a data connection, an expression evaluation engine is configured to unpack the data, and before the data is sent on a data connection, an expression evaluation engine is configured to pack the data.
Embodiment 14 is the method of embodiment 13, wherein unpacking the data or packing the data comprises transforming one or more of the values in the data from one datatype to another datatype, extracting a subset of the one or more values in the data, or evaluating one or more values in the data.
Embodiment 15 is the method of any one of embodiments 1-14, wherein the definition of the data flow graph comprises a priority for one or more of the data connections.
Embodiment 16 is the method of any one of embodiments 1-15, wherein the definition of the data flow graph comprises a permission or a frequency for one or more of the data connections.
Embodiment 17 is a system comprising:
one or more computers; and
one or more storage devices storing instructions that are operable, when executed by the one or more computers, to cause the one or more computers to perform operations comprising:
   receiving a definition of a robotic behavior tree, wherein the robotic behavior tree comprises nodes, wherein leaf nodes of the robotic behavior tree are skills;
   receiving a definition of a data flow graph that describes data connections between skills in the robotic behavior tree, wherein the data connections comprise data with one or more values; and
   executing a robotic process using the definition of the robotic behavior tree and the data flow graph, thereby causing the skills to communicate according to the definition of the data flow graph.
Embodiment 18 is the system of embodiment 17, wherein the definition of the data flow graph describes data connections between skills and services.
Embodiment 19 is the system of any one of embodiments 17-18, wherein the definition of the data flow graph describes data connections between services.
Embodiment 20 is a computer storage medium encoded with a computer program, the program comprising instructions that are operable, when executed by data processing apparatus, to cause the data processing apparatus to perform operations comprising:
receiving a definition of a robotic behavior tree, wherein the robotic behavior tree comprises nodes, wherein leaf nodes of the robotic behavior tree are skills;
receiving a definition of a data flow graph that describes data connections between skills in the robotic behavior tree, wherein the data connections comprise data with one or more values; and
executing a robotic process using the definition of the robotic behavior tree and the data flow graph, thereby causing the skills to communicate according to the definition of the data flow graph.
Embodiment 21 is a system comprising:
one or more computers; and
one or more storage devices storing instructions that are operable, when executed by the one or more computers, to cause the one or more computers to perform the method of any one of embodiments 1 to 16.
Embodiment 22 is a computer storage medium encoded with a computer program, the program comprising instructions that are operable, when executed by data processing apparatus, to cause the data processing apparatus to perform the method of any one of embodiments 1 to 16.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
receiving a definition of a robotic behavior tree, wherein the robotic behavior tree comprises nodes, wherein leaf nodes of the robotic behavior tree are skills;
receiving a definition of a data flow graph that describes data connections between skills in the robotic behavior tree, wherein the data connections comprise data with one or more values; and
executing a robotic process using the definition of the robotic behavior tree and the data flow graph, thereby causing the skills to communicate according to the definition of the data flow graph.

2. The method of claim 1, wherein the definition of the data flow graph describes data connections between skills and services.

3. The method of claim 1, wherein the definition of the data flow graph describes data connections between services.

4. The method of claim 1, wherein executing the robotic process comprises executing the behavior tree and data flow graph asynchronously.

5. The method of claim 4, wherein an executive process executes the behavior tree, and a data process executes the data flow graph.

6. The method of claim 1, wherein causing the skills to communicate comprises passing data between skills on data connections that does not affect the execution of the skills in the behavior tree.

7. The method of claim 2, wherein a skill sending data to the service causes the service to forward the data to one or more recipients.

8. The method of claim 2, wherein the service sending data to a skill does not affect the execution of the skill.

9. The method of claim 3, wherein the service sending data to a second service causes the second service to forward the data to one or more recipients.

10. The method of claim 1, wherein the data connections comprise data with one or more values of one or more datatypes.

11. The method of claim 7, wherein upon the service receiving data without a corresponding recipient, the service stores the received data until receiving a subscription request for the data.

12. The method of claim 1, wherein the definition of the data flow graph comprises how skills in the behavior tree operate if one or more of the values in the data are undefined.

13. The method of claim 1, wherein upon receiving data on a data connection, an expression evaluation engine is configured to unpack the data, and before the data is sent on a data connection, an expression evaluation engine is configured to pack the data.

14. The method of claim 13, wherein unpacking the data or packing the data comprises transforming one or more of the values in the data from one datatype to another datatype, extracting a subset of the one or more values in the data, or evaluating one or more values in the data.

15. The method of claim 1, wherein the definition of the data flow graph comprises a priority for one or more of the data connections.

16. The method of claim 1, wherein the definition of the data flow graph comprises a permission or a frequency for one or more of the data connections.

17. A system comprising:
one or more computers; and
one or more storage devices storing instructions that are operable, when executed by the one or more computers, to cause the one or more computers to perform operations comprising:
receiving a definition of a robotic behavior tree, wherein the robotic behavior tree comprises nodes, wherein leaf nodes of the robotic behavior tree are skills;
receiving a definition of a data flow graph that describes data connections between skills in the robotic behavior tree, wherein the data connections comprise data with one or more values; and
executing a robotic process using the definition of the robotic behavior tree and the data flow graph, thereby causing the skills to communicate according to the definition of the data flow graph.

18. The system of claim 17, wherein the definition of the data flow graph describes data connections between skills and services.

19. The system of claim 17, wherein the definition of the data flow graph describes data connections between services.

20. A computer storage medium encoded with a computer program, the program comprising instructions that are operable, when executed by data processing apparatus, to cause the data processing apparatus to perform operations comprising:
receiving a definition of a robotic behavior tree, wherein the robotic behavior tree comprises nodes, wherein leaf nodes of the robotic behavior tree are skills;
receiving a definition of a data flow graph that describes data connections between skills in the robotic behavior tree, wherein the data connections comprise data with one or more values; and
executing a robotic process using the definition of the robotic behavior tree and the data flow graph, thereby causing the skills to communicate according to the definition of the data flow graph.
